(19) United States
(12) Patent Application Publication
(10) Pub. No.: US 2009/0018695 A1
(43) Pub. Date: Jan. 15, 2009

(54) VENDING MACHINE SERVICE SYSTEM AND METHOD THEREFORE

(76) Inventors: Ira A. Kronenberg, New Orleans, LA (US); Mark S. Kronenberg, Metairie, LA (US)

Correspondence Address: JOSEPH T. REGARD, LTD PLC, PO DRAWER 429, MADISONVILLE, LA, 70447-0429, US

(21) Appl. No.: 12/137,358

(22) Filed: Jun. 11, 2008

Related U.S. Application Data
(63) Continuation of application No. 09/678,915, filed on Oct. 4, 2000, now abandoned.

(51) Int. Cl. G06F 17/00

(52) U.S. Cl. 700/241; 700/231

(57) ABSTRACT

A mono-directional data transmission and receiving system between vending equipment and service vehicles is provided so as to allow service personnel the ability to retrieve information about the vending equipment prior to entering facilities and arriving at the equipment's location. The preferred embodiment of the present invention teaches a monitoring module configured to interface with a communications port or existing DEX/UCS port in a vending machine, the monitoring module configured to periodically poll the equipment to receive operational and/or inventory data, and/or cash data, along with an identifier for identifying the particular equipment, is transmitted to a reception area wherein a mobile service vehicle may be situated to receive said data via a receiver unit, which receiver unit is configured to interface with a portable computer so as to transfer said operational and/or inventory data.

### STATEMENT OF CONTINUING APPLICATION

The present application is a continuation of U.S. Utility patent application Ser. No. 09/678,915 filed Oct. 4, 2000 entitled “Vending Machine Service System and Method Therefore”, listing as inventors Ira A. Kronenberg and Mark S. Kronenberg.

### TECHNICAL FIELD OF THE INVENTION

The present invention relates to systems for communicating operational and status conditions from a remote apparatus to an administrator, and in particular to a system for transmitting vending machine inventory and operational data from one or more vending units to a service vehicle in the general vicinity.

The preferred embodiment of the present invention teaches a monitoring module configured to interface with a communications port or existing DEX/UCS port in a vending machine, the monitoring module configured to periodically poll the equipment to receive operational and/or inventory data, which data, along with an identifier for identifying the particular equipment, is transmitted to a mobile service vehicle at a designated reception area and received via a receiver unit, which receiver unit is configured to interface with a portable computer so as to transfer operational and/or inventory data from said vending machine(s).

In an area with multiple vending machines, transmitters associated with each machine or bank of machines to transmit data independently to the service vehicle. Each transmitter may be configured or calibrated so as to insure optimal reception of the data by the service vehicle in the designated reception area.

The portable computer receiving the data is configured to provide to the route operator/service personnel with operational and/or inventory data on the vending machine(s), so as to allow the service personnel to pull the necessary inventory for stocking the machines without the necessity of a physical inventory, thereby significantly reducing restocking and overall route service time.

In addition to inventory data, the present system also compiles and transmits coin box activity, which can be used in implementing a coin box balance feature by the route operator. In such an application, a portable computer displays activity relating to coin box or product inventory changes from the period of reception at the service vehicle to the point where the unit is opened for replenishing inventory and emptying the coin box, so that the operator may properly balance out the unit.

### BACKGROUND OF THE INVENTION

Currently vending machine service personnel must park their route truck outside of a facility containing one or many vending machines. These facilities can include, for example, small buildings, large factories, or tall office buildings. The service personnel must then go to each machine, record the necessary product and cash inventory needed by each machine, and then return to the truck to pull this inventory. In pulling the inventory the service person must count out the quantity of each product needed because the driver cannot accommodate transporting full cases of each product between the truck and machines. Many times a service person will handle as many as 80 different products within a facility and that many cases will not fit on a hand truck.

In some instances route service personnel will guess what the inventory requirements will be for the machines within the facility but cannot adequately service the equipment because they will not always have enough inventory when they get to the machine and often have products that do not sell in the specific machines.

There is current technology whereby vending equipment can provide current and historical data to an external collection device via a direct connection to a DEX/UCS port. Utilizing In current technology, companies and individuals are using portable computers to retrieve this data and provide it to the route service personnel as well as management systems at the company offices. In this technology however, the route service personnel must first travel to the machine in order to plug in the collection device.

In addition, the DEX/UCS information provided by the vending machines consists of a large amount of data such as coins and currency put in the machine, amount of coins refunded by the machine, amount of coin and currency that goes into the money box in the machine, the amount of currency that goes into the bill validator that verifies currency, the amount of coins that go into the coin changer that verifies coins and provides change, the amount of product that is sold in the machine, the amount of free vends made by the machine, machine identification information, and much more.

While the information provided via the DEX/UCS interface is detailed, it is more than is required for normal inventory replenishing and cash box collection.

Because the above route methods require that the driver physically inventory each machine, travel to the service van to collect the stock, then travel back to the vending machine for replenishing, an inordinate amount of time generally passes between the time of inventory and the replenishing of the machine. Additional sales of items will occur during this intermediary period, which will result in the machine not being properly stocked or cashed out even after it has been serviced.

While the prior art may include vending machines having transmitters for relaying inventory or operational data to a remote location, these systems have been designed for bi-directional communications with a remote, central office, which administers the machines from a distance, as opposed to a system which transmits data efficiently and cheaply directly to a service vehicle within the immediate vicinity of the machines.

Such prior art systems have relied upon cellular telephone modems, direct to satellite systems, land line telephones, and trunk RF relay systems for said communications. In all such instances, the system was bi-directional, and either very expensive to implement and maintain or impractical in its requirements or operation.

The prior art systems are believed to universally require two way transmission wherein a handshake is required to convey the data, and wherein the data is compiled over time and prepared for selective transmission at the origin for reception by the user, generally at the request of the recipient, and after the transmission is complete, receipt of the transmission is acknowledged prior to termination.

Even where the prior art may reference “one way” communication in some capacity, such a reference is with regard to the conveyance of certain data as a component in a sequence of transactions, and believed not a reference of the means of communication, which as shown requires at the very least a handshake to establish and terminate communication, which in and of itself is two way in its operation as previously discussed. Such two way operation is substantially more complex and costly to implement than a pure monodirectional data stream, although a fully monodirectional conveyance of data has its own problems.

In a pure monodirectional transmission from a transmitter to a receiver (as in the present case), the transmitter in effect transmits blind, that is, the transmitter has have no capacity to discern whether the transmission has been received. This presents certain challenges, although if such as system can be provided, there are obvious benefits with regard to cost of implementation and operation.

### GENERAL SUMMARY DISCUSSION OF THE INVENTION

Unlike the prior art, the present invention teaches a system for service vehicle monitoring of vending machines for route servicing which provides current, accurate, relevant information, while being relatively cost effective in installation and maintenance, and reliable in operation.

For years the vending industry has worked to produce a system which would allow vending equipment to export information about the operation of that equipment and provide management information such as the amount of product sold, the value of the product sold, the amount of cash received, etc. The resulting specification is known as the DEX/USC specification, which can export all data fields to a secondary device outside of the vending machine, which can be programmed for various operations including maintenance, sales data, inventory replenishing, or the like.

The preferred embodiment of the present invention teaches a system for managing vending machines and the like, wherein there is provided a monitoring assembly configured to interface with existing machines via a universal data port (UDP), for example, a DEX/UCS data port, or RS-232 corn port, which assembly monitors inventory and coin box activity as reported by the port from the machine, and reports same via a transmitted RF stream to a service van in the vicinity of the machine(s).

The service van receives the data from a transmitter assembly, which is configured to interface with a portable computer device, which device displays or otherwise utilizes the received data to compile and communicate inventory, operational status, cash box, and other information to the operator for use in replenishing and servicing the machine(s).

What is believed to set the present system apart from prior art reporting systems is that the present system is configured to provide real-time information from vending machines at a facility to a service vehicle situated in the vicinity of the machines.

In use, the service vehicle would park in the vicinity of the machines, in an area which may be pre-designated, and receive transmissions from vending machines within walking distance therefrom, so as to enable the service person to collect the inventory, change, and other items necessary to replenish the machines prior to visiting the machines.

At the vending machine(s) the monitoring assembly of the present invention periodically polls the vending machine via the DEX/UCS port to retrieve selective, relevant data. A microprocessor associated with the monitoring assembly retrieves relevant data from a data stream to filter down the data to that which is relevant to the route operator, which filtered data is then transmitted as a data stream, with an identifier appended to the stream identifying the particular machine. It is important that the data stream be as short as possible as, in the preferred embodiment of the machine, each machine or bank of machines may simultaneously transmit its own data stream with identification information for each machine. To keep costs to a minimum, the preferred embodiment of the machine contemplates one-way transmissions of data via RF from the machines to the route vehicle in the form of independent, repeated transmissions of each data stream from each machine or set of machines.

Alternatively, the transmissions can be synchronized by time to avoid simultaneous transmissions interrupting each other, or separate frequencies, frequency hopping, spread spectrum, or other transmittal technique could be utilized to insure proper reception of each data stream transmission.

When a route driver reaches a designated area, a receiving module situated within and ideally powered by the route vehicle receives the transmission from the machine, transferring the data (via, for example, a cable connection) to a hand held computer which generates a picking ticket with the identity of the machine and required inventory; coin information may also be provided so as to replenish change stock in the machine and information as to the amount of cash to be brought back to the corporate office.

The DEX/UCS data provides intricate and detailed information on the operations of each vending machine, much of which is irrelevant to the route operator from an inventory and cash out standpoint. Because the monitoring assembly is programmed to filter out the extraneous data to that required for inventory and money management, thereby providing a reduced set of data, a decrease in transmitting time is achieved, streamlining transmission and simplifying the route process. The processor reading the DEX/UCS information may utilize both cumulative as well as interval data provided to compute the appropriate values. The receiver mounted in the truck may be configured to run on 12 volts and obtain power from the service van.

The present system is designed to be utilized with a plurality of machines in diverse areas within a limited vicinity, generally about 1 mile line of sight. The machines can be arranged on multiple floors of several nearby buildings. A transmitter may be mounted to a single machine, or may be shared by a bank of adjoining machines as a network. A transmitter mounted to a bank of machines would transmit a data stream for each of the vending machines in the bank. The hand held computer can be configured to arrange services instructions for each machine in an order corresponding to a route which the route operator may follow from the van, and the hand held unit may include in memory instructions relating to the location of each machine, for use by a new operator or for large facilities.

Thus, the inventory may be arranged in an order which follows the delivery procedure chronologically for each machine along the route, in order to further speed up the efficiency of the service process, by indicating specific inventory product for each slot in the vending machine.

A database program in the portable computer device can be programmed to utilize the raw operational data from the received data stream to translate machine operations, i.e., chute deployments via motor movements, into actual product dispensed for those reporting systems which provide only this basic information.

In addition to individual inventories for each machine, the portable computer may provide totals of product required for the entire route, so that the operator can determine if enough product is available in the service vehicle for replenishing the total inventory, and, if not, whether and what type of substitutes will be provided. Such substitutes may be noted by the operator in the database for future reference. Power outage data may also be provided to the route operator in the form of a signal from the monitoring module transmitted to the route operator indicating a power outage occurred, which indication can also include time and duration of the outage. In the alternative, an indicator light or other signal may be provided to the operator when the operator opens the machine to be serviced, to indicate whether a power outage has occurred.

The coin data provided in the data stream allows the service personnel to convey to each machine the exact amount of change necessary to restock the coin tubes, thereby reducing the amount of monies carried by the personnel. The total amount of money in the cash box of each machine may be included in the data stream transmitted to the receiving unit, as indicated, so that the portable computer may be brought to the home office after completion of the route, the information on the inventory stocked, change dispensed, and monies received by each machine downloaded into the computer, and the information utilized for the records and to verify the monies and stock returned by the driver.

During each route, upon replenishing each machine, the route operator will activate a reset switch for each machine in order to reset the counters within the monitor unit, indicating that the machine has been fully stocked.

In operation, the present invention provides a one-way RF communication from the vending machine(s) to a predesignated reception area in such a manner as to provide continuously updated data streams for each machine, such that said data streams are conveyed to said designated reception area in approximate real time even where the transmission is “blind”.

This is accomplished by continuously repeating over time the steps of:

a) polling said machine, compiling sales and cash flow data, providing a data stream;

b) repeatedly transmitting said data stream, utilizing monodirectional RF transmission only, providing a continue transmission within a reception area;

Thus, the predesignated reception area has beamed to it a continuously data stream which can be received at any time the moment service vehicle is in the reception area, said received data stream updated in approximate real time, so that the operator can be assured that the received data is accurate at the time of reception.

Unlike the prior art, the present invention does not require subscription fees, costly equipment, or even an FCC license, providing a system which is substantially less expensive to initiate and maintain than prior art systems.

As discussed, the present invention provides a system which utilizes a portable computer configured to receive the data from the receiver at the service vehicle, compile same, and communicate to the operator the relevant data to pull the inventory at the service vehicle.

As indicated, the portable computer can then be utilized by the operator during the process of servicing the vending machines as a means to locate and provide the optimal order of servicing the machines based upon location and the inventory requirements. Finally, the portable computer may be utilized to “balance out” the vending machine data at the vending machine location during the service process, which adjusted vending machine data is then conveyed back to the base office to provide the most accurate data available on the machines. This partnering of a portable computer with the above process is likewise unique an not contemplated in the cited prior art.

Accordingly, the claims set forth a specific protocol to deal with transactions which occurred during the interval following receipt of the vending data but before servicing of the machines. These steps, if followed, allow the user to compensate for these changes in inventory and cash box, and provide an adjusted data which can ultimately be conveyed, for example via the portable computer, to the base office.

The above steps (as well as the other claims) were developed to compensate for the difficulties in dealing with a purely one way, “blind” transfer of data from the transmitter to the reception area, and is not contemplated, suggested, or otherwise taught, alone or in combination by the cited prior art.

One of the things that sets the present invention apart from the prior art is the ability to provide an accurate and highly efficient system for servicing vending machines utilizing the monodirectional transmission (only) via a unique, defined series of important steps which compensate for the difficulties of a monodirectional system and which, and which if not followed, would result in an unworkable system. The invention is thus much more than the simple “one way” transmission of data.

The invention thereby provides a unique, innovative and accurate system for servicing vending machine(s) from a service vehicle in a manner which requires much less equipment investment than prior art systems, and with no subscription or service plan requirements for conveying the data.

The present invention is thus believed to fulfill a long felt but unresolved need for a system for transmitting from a vending machine real time inventory, collection, and/or operational conditions to a service vehicle within the immediate vicinity for utilization by the route operator in replenishing and cashing out the machines, which system is relatively universal in operation, as well as being inexpensive to implement and maintain.

It is therefore an object of the present invention to provide a system for transmitting inventory, change, and cash box data from a vending unit to a service vehicle within the vicinity which may be added to most vending machines on the market incorporating communications ports.

It is another object of the present invention to provide a system for simplifying a vending machine route by eliminating the need for an initial trip to the machines to discern inventory requirements.

It is another object of the present invention to provide a system for communicating vending machine status, inventory, cash box, and related information to a nearby service vehicle which is relatively easy to implement, inexpensive to operate and maintain, and reliable in operation.

It is another object of the present invention to provide a system for transmitting cumulative data from a plurality of vending machines within a local area to a hand held computer, which computer may be utilized for gathering inventory for replenishing or restocking the machines, providing change for the machines, as well as providing cash box data for the home office for verification of monies received, for increasing accuracy in bookkeeping as well as reducing theft.

It is another object of the present invention to provide a system for receiving simultaneous transmissions from a plurality of vending machines and incorporating same into a pick ticket which includes the inventory requirements for each machine in order of the route schedule, thereby simplifying the task for the operator.

Lastly, it is an object of the present invention to provide a method and system for providing transmissions from a plurality of vending machines in diverse locations in a local area so that said transmissions overlap in at least one predesignated reception area where a service vehicle can locate to receive status data from said plurality of machines.

### BRIEF DESCRIPTION OF DRAWINGS

For a further understanding of the nature and objects of the present invention, reference should be had to the following detailed description, taken in conjunction with the accompanying drawings, in which like parts are given like reference numerals, and wherein:

FIG. 1 is an isometric view of the overall system of the present invention, illustrating multiple vending units at disparate locations within a local area transmitting data to a route vehicle.

FIG. 2 is a top, partially cut-away view of the invention of FIG. 1, illustrating the reception range of the transmitters to an exemplary reception area.

FIG. 3 is a front view of an exemplary vending machine of the present invention, illustrating the various components of the machine and the transmitter module, with an exemplary external antenna mounted thereupon for illustration purposes.

FIG. 4 is an overall schematic view of the equipment utilized in facilitating the present invention.

FIG. 5A is a top view of an exemplary portable computer device or hand held computer of the present invention.

FIG. 5B is a top view of an exemplary portable computer device or hand held computer of the present invention.

FIG. 6 is a flow chart illustrating an exemplary operation of the hand held computer of FIGS. 5A and 5B.

FIG. 7 illustrates the various steps in accomplishing a method of the present invention.

### DETAILED DISCUSSION OF THE INVENTION

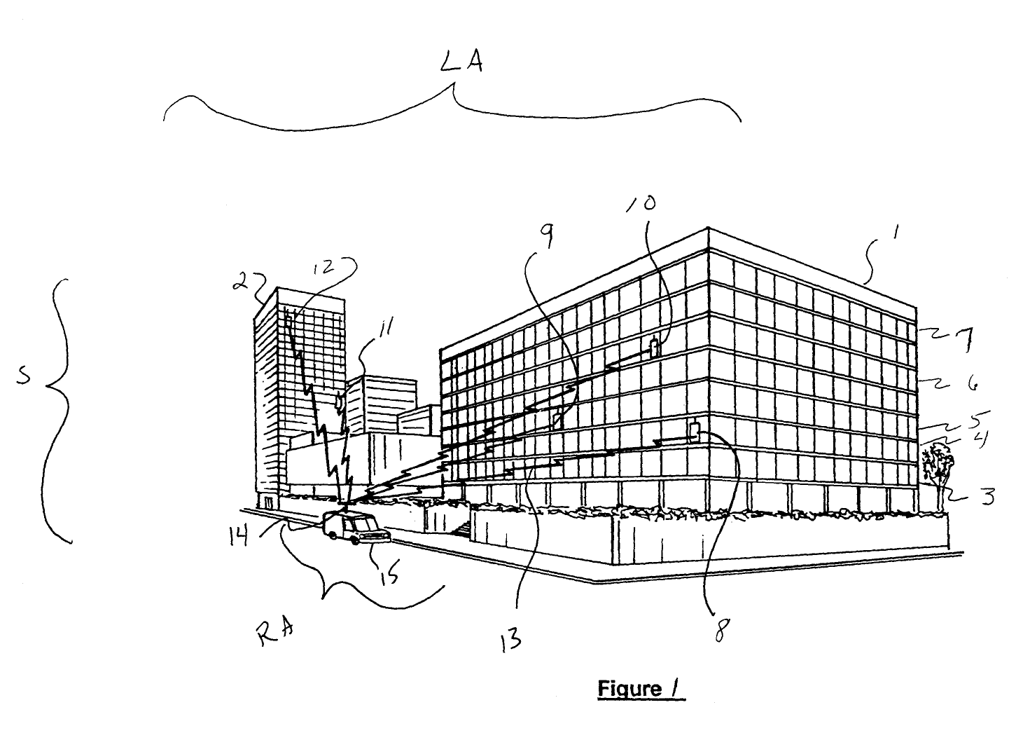

Referring to FIG. 1, the system of the present invention S is configured to be implemented at a local area LA wherein there are provided a plurality of vending machines 8, 9, 10, 11, 12 situated in spaced relationship from one another and a service vehicle, although it is noted that the present system can be utilized with a single machine where it is located a distance from the service vehicle. As shown, an exemplary location could comprise, for example, first 1 and second 2 buildings, the first building shown having floors 3, 4, 5, 6, 7, the second building also having multiple floors, wherein there is located in diverse locations vending machines 8, 9, 10, 11, 12, each vending machine having a transmitter for transmitting 13 a data stream continuously, or at periodic intervals, the transmission directed to a service van 15 having a receiver and an antenna 14, situated within a reception area RA. Unlike the external antenna shown, the present system may also utilize an internal antenna

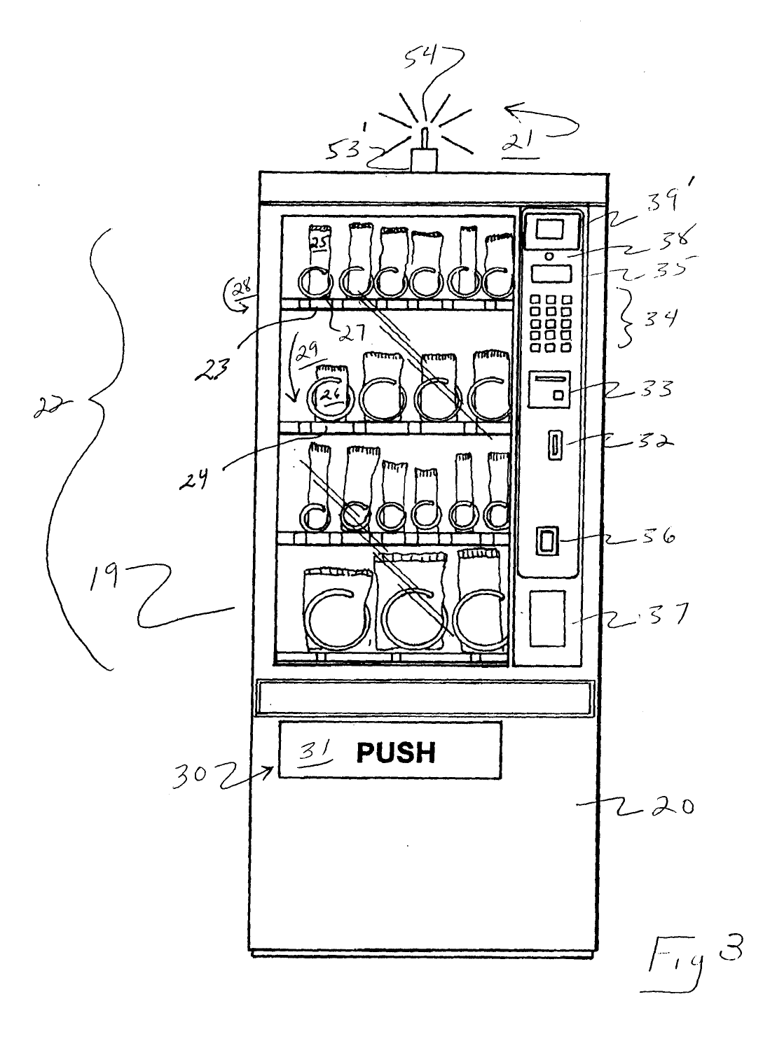

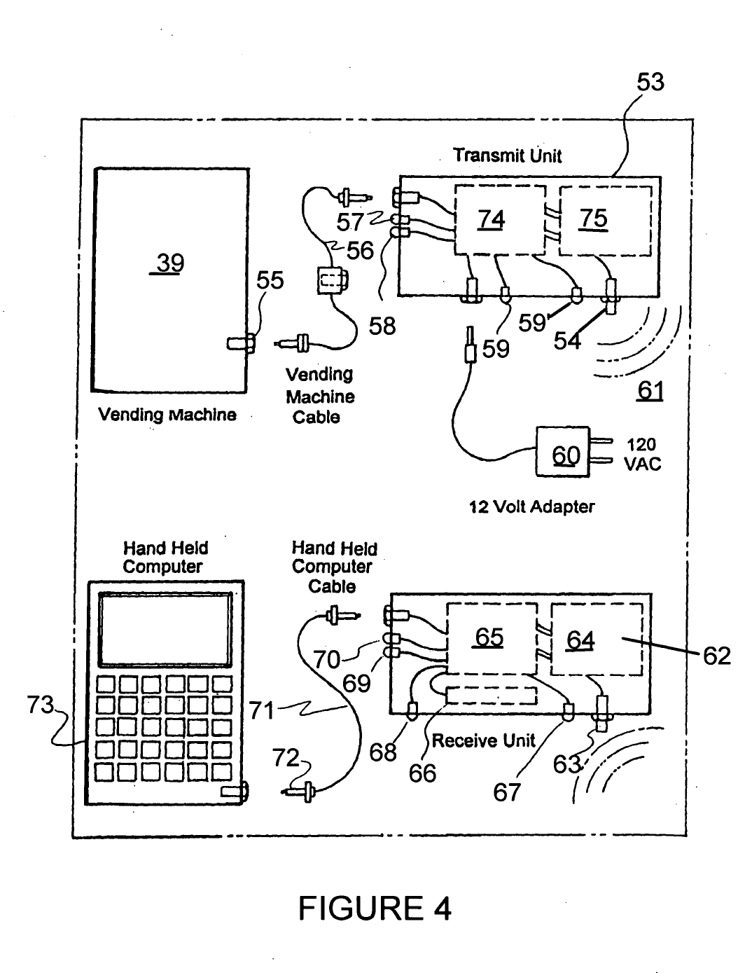

Continuing with FIGS. 1, 3, and 4, the transmitter unit 53, 53′ of the present invention is configured to be retrofitted to a vending machine 39, 19 which has a data port 55 configured to provide data via the DEX/UCS standard (or some other standard) from the CPU/controller board 39′ of the machine.

The CPU/Controller board controls the functions of the machine, including dispensing of product 25, 26, situated in chutes 23, 24, and displayed in a selection area 22 product which is selected by the customer via input pad 34 (which may include a display 35. Payment is made via coin slot 32 or bill machine 33, while change is provided automatically via the change slot 36. Coin return button 38 is typically provided to allow the customer the ability to refund the coins placed in the machine, should they change their mind as to a purchase.

In the present example, a dispensing coil 27 retaining the selected product is configured to rotate 28 via a step motor which is energized via instructions from the CPU/controller board after payment is acknowledged and selection made; other dispensing means are well known and practiced in the art as well for diverse vending machines including can dispensers (soft drink machines), cigarette machines, sandwich machines, beverage/cup machines (coffee machines) and many others, any of which could be adopted to work with the system of the present invention. In the exemplary machine shown, the product 25 is dispensed 29 to a retrieval bin 30 where it is retrieved by the customer via door 31. Coin payment is accumulated in a cash box 37.

Inventory replenishing of product, servicing of the machine, and retrieval of the cash is typically accomplished by opening 21 the front panel 20 of the machine, which is hingedly joined to the body of the machine and locked in place like a door.

All of the functions of the machine are reported by the CPU/Controller board to the DEX/UCS port 55 including, for example, coins and currency put in the machine, amount of coin refunded by the machine, amount of coin and currency that goes into the money box in the machine, the amount of currency that goes into the bill validator that verifies currency, the amount of coins that go into the coin changer that verifies coins and provides change, the amount of product that sold in the machine, the amount of free vends made by the machine, machine identification information, etc. Other systems may provide more basic data, such as the amount of times that a particular motor turned, indirectly indicating how much product was dispensed by that motor.

The present invention summarizes this data into useable form and transmits same so that it may be received by a service van 15 after it arrives at the route location or local area LA. In accomplishing this task, a transmit unit 53 is provided to receive, manipulate, and transmit the data from the vending machine, the transmit unit first having a monitoring assembly 74 which receives the data from the DEX/UCS port 55 via an interface cable 56.

The monitoring assembly 74 periodically polls the DEX/UCS port of the vending machine to gather data, processing same and accumulating totals for product and cash inventory, and utilizes said raw data to compile in real time sales totals for each selection carried by the machine or bank of machines, cash received, coin change status, as well as an identifier for identifying each machine in association with said totals, cumulatively referred to as inventory data.

When determining the quantities provided by DEX/UCS, the monitor assembly must perform several calculations. In the preferred embodiment of the invention, the DEX/USC provides data in the form of cumulative values, which never reset and/or interval data that resets each time the machine is read. The monitoring assembly 74 should first determine what type of values, cumulative or interval, are represented. The preferred embodiment of the system of the present invention, as currently programmed, automatically uses cumulative data if it is available and if it is not then uses interval data.

If the machine utilizes cumulative values, the monitoring assembly 74 compares the cumulative values from the last time the vending machine was polled to the differences updated in the monitor unit as the sales values. If no cumulative values exist, then the interval values will be added to the sales values stored in the monitoring assembly. The monitor unit should include a reset switch to reset the counters by the operator whenever the vending machine is restocked, so that the monitoring unit will reset and begin to accumulate new sales figures for the next service.

This inventory and other data should be converted from its format (for example RS232 to TTL for transmission via a TTL converter, as it is relayed to a transmitter module 75 which transmits a signal 61 incorporating said data via an antenna 54. The preferred embodiment of the invention contemplates RF transmission, but other communication means, including laser, fiber optic, RF, cable, or other means may be likewise utilized. RF transmission could be via a single frequency, spread spectrum, frequency hopping, BPSK, or other technique could be similarly utilized to communicate the data directly to the service vehicle.

The transmit unit 53 may be situated within the vending machine and accessible by the door, or may be mounted upon the unit in the vicinity of the antenna, and may include status lights or LEDs so as to power 59′, receipt of data from vending machine 58, transmission of data to the vending machine 58 (in two way applications), and transmit data to the transmitter module 75 light 59. Power for the transmitter unit 53 may be provided by an AC adapter 60, or alternatively by the vending machine power supply.

Each of the vending machines may incorporate its own transmitter unit for independent transmission to the van, and/or a bank of adjacent or nearby machines may be networked via a hub or the like to a single transmitter unit, which would likewise compile a data stream for each vending machine in the network, identifying the machine and inventory and cash data as part of the data stream. In addition to inventory and cash data, operational status information, such as mechanical malfunctions, tampering, power failure, and other operational irregularities may also be transmitted as part of the data stream utilizing existing software, hardware and transmission techniques.

Exemplary lights which may be provided in the preferred embodiment include power, transmit, receive, DEX (lit when polling), TU (lit when monitor unit is talking to transmitter), and reset. The present transmitter transmits data via spread spectrum technique at a frequency of about 900 MHZ and power of 50 mA having an anticipated range in the city of about 2000 feet (about 0.3 mile) and an unobstructed range of about 1 mile Of course, the performance of the present system can vary substantially depending upon obstructions, electromagnetic interference, geography, position, and other factors.

The service van 15, which carries inventory and the route operator, has situated therein the receiver unit 62 which includes a receiver module 64 which receives a signal via the antenna 14 in the vicinity of the vehicle via antenna port 63, and relays said signal to an interface module 65, which converts said data to a useable format which may be understood and processed to a hand held or portable computer 73 via transfer cable 71 and cable port 72. The receiver unit 62 may include a power light or LED 66, a receive light 67 to indicate receipt of data from the receiver module, a receiver data transmit light 68, and a receive data from portable computer light 69.

In use, the service route operator would arrive in the route vehicle 15, and park the vehicle 15 in an area known to receive signals from all vending machines to be serviced. Upon arriving at a reception area RA, the receiver unit 62 receives a signal transmitted independently by vending machines 8, 9, and 10 in the first building 1, and vending machines 11, 12 in the second building 2. The data is downloaded to the hand held or portable computer 73, which takes the data and generates same for use by the route operator.

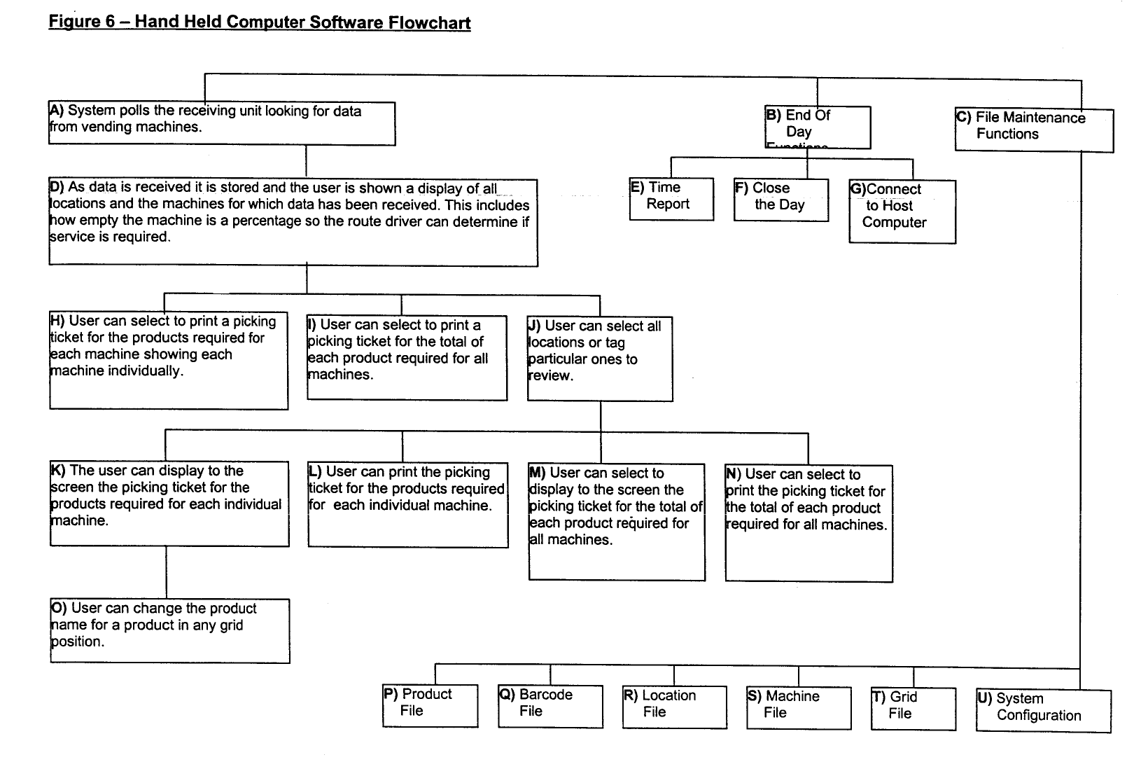

Continuing with FIGS. 1, 5A, and 6, the hand held or portable computer 73 receives the transmitted data from the receiver and is programmed to display via display screen 76 data representing status of the vending machines whose transmissions were received. Control and data input of the computer is accomplished via alphanumeric keypad 77.

Programming and software utilized by the unit may vary and may utilize reasonable skill to accomplish, and may take the form of a database of each machine, each dispensing chute for each machine and its location on the machine, and detailed cash and change data on the machine, as well as detailed location information on the machine. Further route data on the most efficient order to service machines may be programmed into the unit so as to direct the operator to each machine on the route in the most efficient order, allowing the operator to compile inventory according to each machine in the route in proper order for the route.

Other data may be provided; for example, the portable computer 73 display may indicate the general location 78, 78′ of a machine or bank of machines, and give inventory summaries by category of machine 79, 79′, respectively, so that the route driver can determine that sufficient sales have occurred to justify restocking the machines.

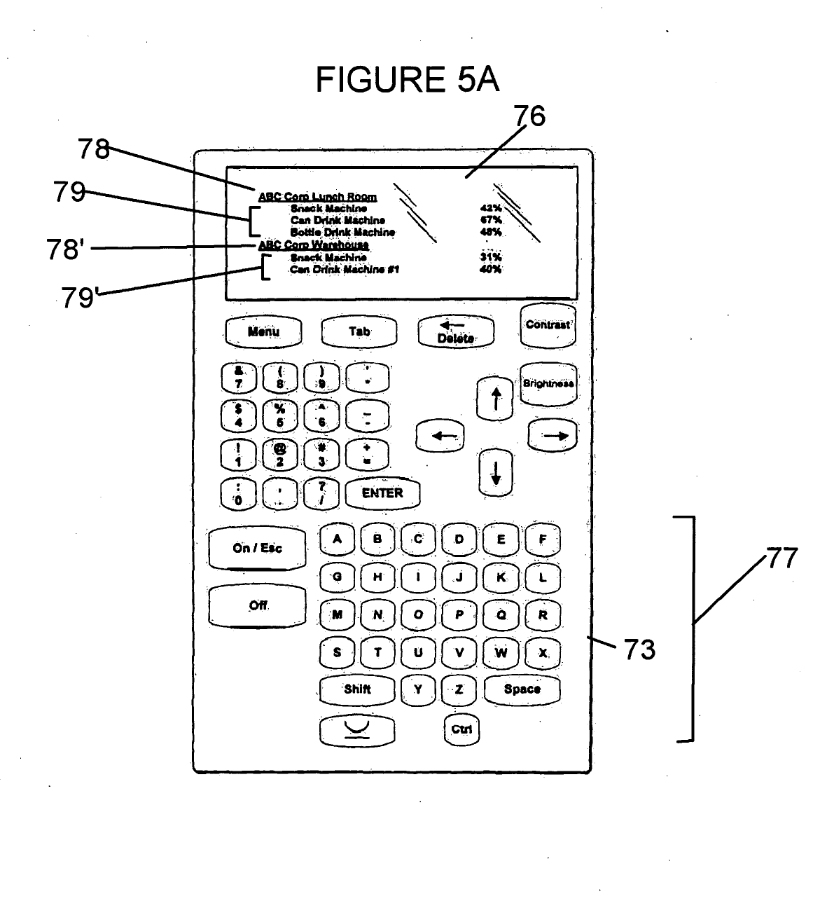

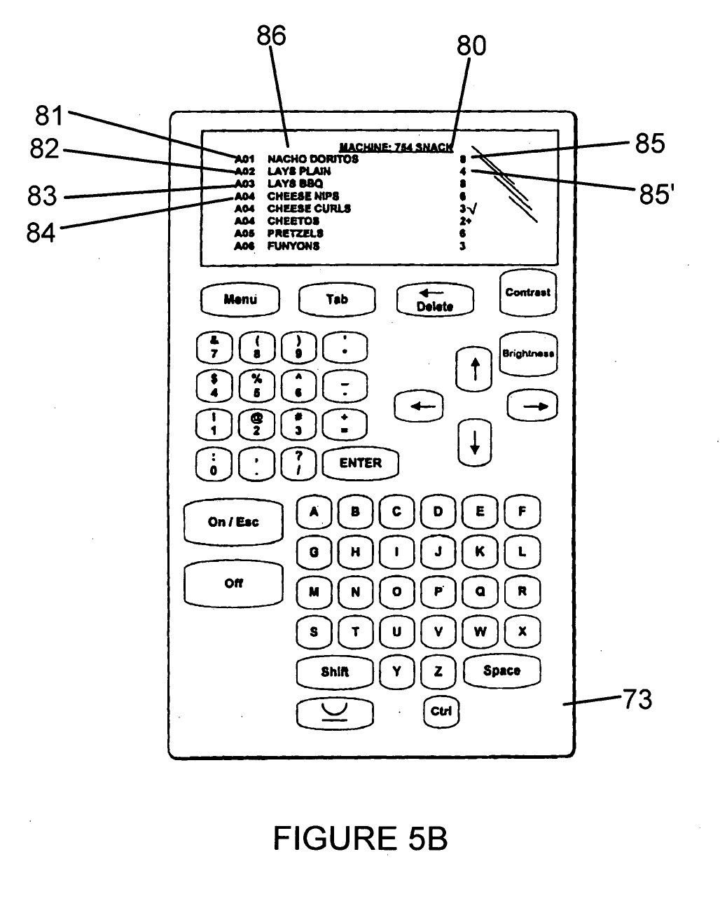

As shown in FIG. 5B, in preparing the inventory list, or “picking ticket” (which can be displayed or printed) the portable computer 73 indicates the particular machine 80, which may have an identifier number (and may also indicate the location or other description), and indicates each dispensing chute 81, 82, 83, 84, and corresponding sales data 85, 86 for each said chute, so that the stock may be pulled from the inventory on the service or route vehicle in preparation for replenishing same.

As indicated, the machines may be presented in a particular order corresponding to the best, most efficient order on the route to service the machines, and may include descriptive criteria including the building, floor, directions, pass codes, access hours, or other information which may be programmed in via the alphanumeric keyboard or at the office.

Further, substitutions may be indicated on the machine via programmed data from the office, or messages or notes may be inputted regarding machine operations or observations for the office or service personnel to refer to at a later time.

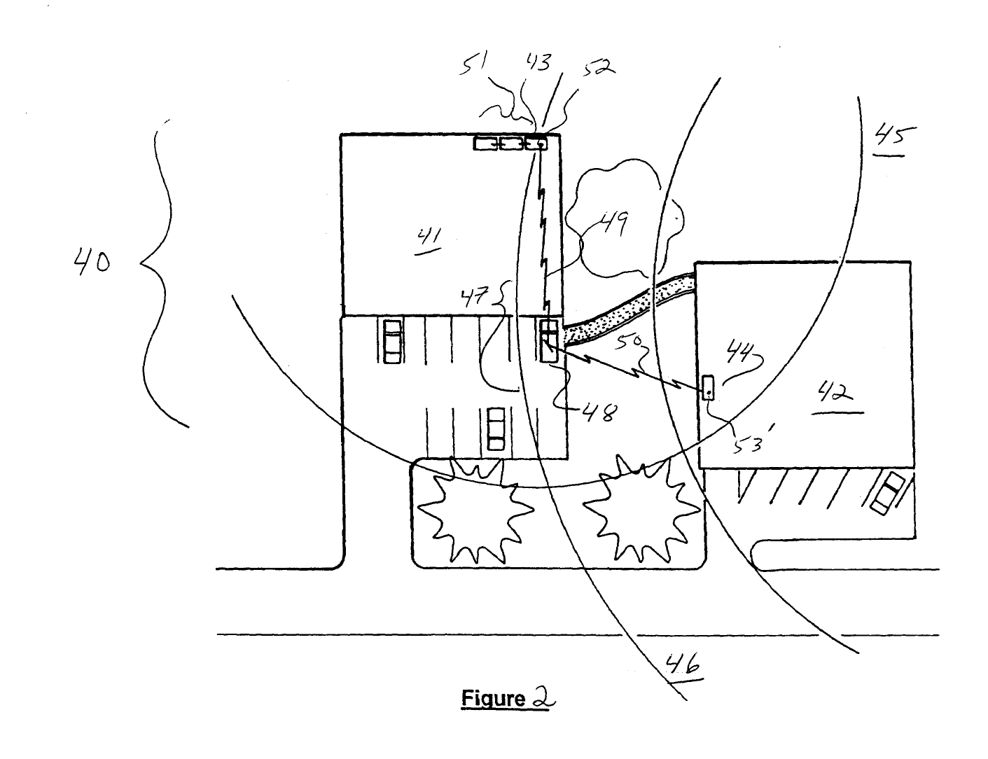

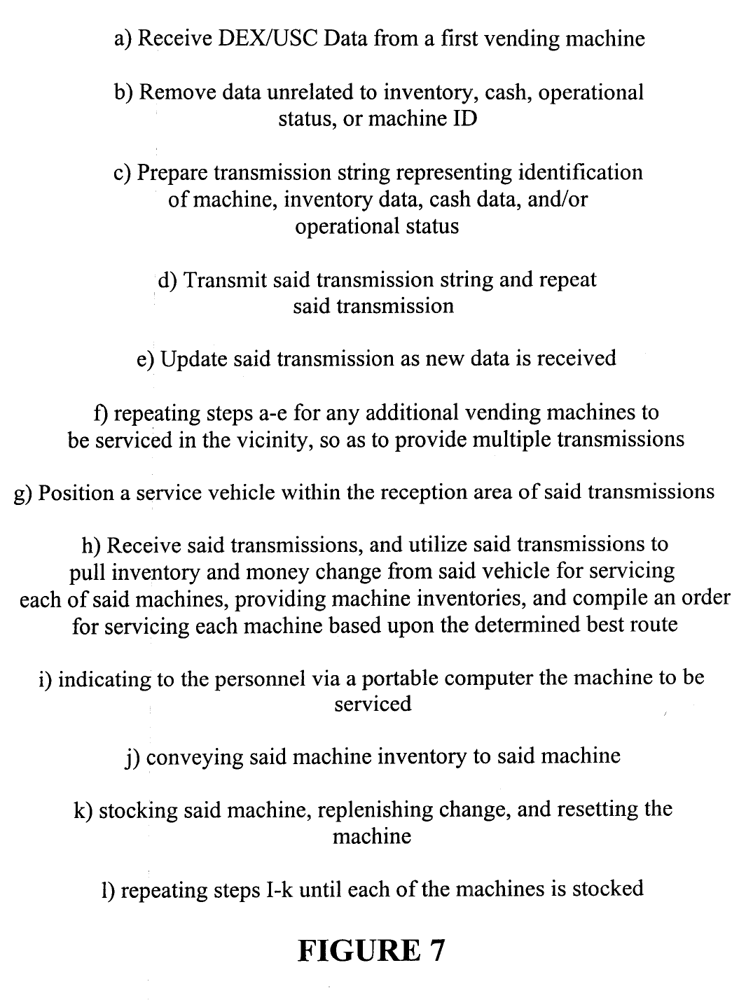

As shown in FIGS. 2 and 7, a summary of a method of the present invention may be expressed as follows:

a) Receive DEX/USC Data from a first vending machine 43 via the monitoring assembly, in the manner discussed above.

b) Remove data unrelated to inventory, cash, operational status, or machine ID utilizing programming in the monitoring assembly, as earlier discussed.

c) Prepare transmission string representing identification of machine, inventory data, cash data, and/or operational status, and forwarding said transmission string to said transmitter module;

d) Transmitting 49 said transmission string to broadcast within limited transmission range 45, 45 within a limited, local area 40, and repeating said transmission to maintain a flow of data on said machine to the reception area 47; while

e) Updating said transmission string as new data is received, for example, as might occur with each sale of product from said machine.

f) repeating steps a-e for any additional vending machines 51, 44 to be serviced in the vicinity, so as to provide multiple transmissions 49, 50 to the reception area;

g) Position a service 48 vehicle within the reception area 47 of said transmissions;

h) Receive said transmissions, and utilize said transmissions via the portable computer to pull inventory and money change from said vehicle for servicing each of said machines, providing stock for filling machine inventories, as well as compiling an ordered list for servicing each machine based upon the determined best schedule.

l) indicating to the personnel via a portable computer display which machine is to be serviced next (may include information on which building 41, 42, floor, or other description of location);

j) allowing the service personnel to convey said machine inventory to said machine;

k) stocking said machine, replenishing change, and resetting the machine;

l) repeating steps I-k until each of the machines is stocked;

m) returning to the service van with the portable computer;

n) when more areas are to be serviced, traveling to the next local area LA and repeat steps a-m

o) uploading data from the portable computer to the administrative office and downloading data from the administrative office to the portable computer.

As earlier indicated, a bank of machines 51 can share a common transmitter 52 if the machines are located in the immediate vicinity of one another, thereby lessening the amount of hardware needed, as well as RF emissions in the locale.

The software on the hand held or portable computer should allow the service personnel to adjust the inventory level on each machine for each product, so that accurate product requirements can be calculated. For example, if a machine will hold 20 pieces of a product in one selection, and the driver only leaves 18 units in the machine when it is finished being serviced, then the software on the portable computer must account for the shortage of those two units.

Since the vending machine may only provide information about the number of units that were sold from the machine, in order to provide the employee with an accurate count, the software in the portable computer should add the two that were missing to the value provided by the vending machine. An example would be if the vending machine indicates that five product were sold but we know that the employee left two units empty in the machine the last time, then the portable software should indicate that seven units are required.

An example of a programming chart for the hand held, or portable computer used in the present invention for the route servicing of the vending machines is shown in FIGS. 1, 4, and 6.

As shown, after the route vehicle 15 arrives in the reception area RA, the hand-held or portable computer unit:
polls the receiver unit 62 to discern reception of data from all of the vending machines known in the area;
the data from the various machines in the area is stored, the user/operator is shown a display of all locations and the machines for which data has been received. This may include how empty the machine is to enable the user/operator to determine if service is required;
user then has different choices as to how to pull inventory for the machines in the area, namely:
   the user/operator can select to print a picking ticket for the products required for each machine showing each machine individually; or
   user can select to print a picking ticket for the total of each product required for all machines; or
   user can select all locations or tag particular ones to view; then
      the user can then display to the screen 53 the picking ticket for the products required for each individual machine; or
      the user can print the picking ticket for the products required for each individual machine; or
      the user can select to display to the screen the picking ticket for the total of each product required for all machines; or
      the user can select to print the picking ticket for the total of each product required for all machines;

The user may change the product name for any product in the inventory, which may be displayed as a list or in the form of a grid in a spreadsheet or the like.

At the end of the day, the hand-held or portable computer can provide:
a time report on events which occurred during the day;
close the day; and/or
connect to the host computer and upload the data of the day for the route serviced.

Miscellaneous file maintenance functions may be performed on the:
product file
bar code file
location file
machine file
dispensing chute or more commonly referred to as grid file; or
system configuration.

The present invention thereby provides a system which utilizes the vending machine data at a site to reduce it to an efficient, useable form, transmitting the data to an arriving service or route vehicle, and providing to the route operator or service personnel the inventory and/or other information they need at the vehicle before they visit the machine, so as to increase employee efficiency, reduce service time, and improve inventory control. The information stored in the portable computer and downloaded to the administrative office further allows for better merchandising of the vending machine, and this, coupled with the more efficient servicing of the units results in increased overall sales.

A summary of the reference numerals and descriptions utilized in the present application follows:

| Element | Description |
|---|---|
| S | System of present invention |
| LA | Local Area |
| RA | Reception Area |
| 1 | first building |
| 2 | second building |
| 3 | first floor |
| 4 | second floor |
| 5 | third floor |
| 6 | fourth floor |
| 7 | ninth floor |
| 8 | vm1 |
| 9 | vm2 |
| 10 | vm3 |
| 11 | vm4 |
| 12 | vm5 |
| 13 | transmit |
| 14 | antenna |
| 15 | service van |
| 16 | reception antenna |
| 17 | |
| 18 | |
| 19 | vending machine |
| 20 | front panel/door |
| 21 | opens |
| 22 | selection area |
| 23 | chute |
| 24 | chute |
| 25 | product |
| 26 | product |
| 27 | dispensing coil |
| 28 | rotate |
| 29 | dispense |
| 30 | retrieval bin |
| 31 | door |
| 32 | coin slot |
| 33 | bill machine |
| 34 | selection pad |
| 35 | display |
| 36 | change slot |
| 37 | cash box |
| 38 | coin return |
| 39 | vending machine |
| 39′ | CPU/controller board |
| 40 | local area 2 |
| 41 | building one |
| 42 | b2 |
| 43 | vm1 |
| 44 | vm2 |
| 45 | range 1 |
| 46 | range 2 |
| 47 | reception area |
| 48 | van |
| 49 | receives |
| 50 | receives |
| 51 | bank of machines |
| 52 | common transmitter |
| 53,′,″ | transmitter |
| 54,′ | antenna |
| 55 | dex port |
| 56 | cable |
| 57 | receive light |
| 58 | transmit 1 light |
| 59 | transmit 2 light |
| 59′ | power light |
| 60 | power source |
| 61 | transmission RF |
| 62 | receiver |
| 63 | antenna |
| 64 | reception module |
| 65 | interface module |
| 66 | status display |
| 67 | power light |
| 68 | receive data led |
| 69 | data to portable computer led |
| 70 | data from portable computer led |
| 71 | interface cable |
| 72 | port |
| 73 | portable computer |
| 74 | monitoring assembly |
| 75 | transmitter |
| 76 | display |
| 77 | alphanumeric keypad |
| 78 | location information |
| 79 | general machine type inventory summary |
| 80 | particular machine identification number/indicator |
| 81 | dispensing chute data |
| 82 | ″ |
| 83 | ″ |
| 84 | ″ |
| 85 | sales data for particular chute |
| 86 | name of item in chute |

The invention embodiments herein described are done so in detail for exemplary purposes only, and may be subject to many different variations in design, structure, application and operation methodology. Thus, the detailed disclosures therein should be interpreted in an illustrative, exemplary manner, and not in a limited sense.

What is claimed is:

1. A system for mono-directionally transmitting vending data from a vending machine to a service operator, comprising:
a monitoring interface for compiling data on the operation of said vending machine, providing compiled data comprising machine identification and sales data on the vending machine, said monitoring interface programmed to format said compiled data into a data stream;
a transmitter for transmitting, via mono-directional transmission only, said data stream to a designated reception area, providing a transmission;
a service vehicle situated in said reception area, said service vehicle for conveying an inventory of product for the vending machine, said service vehicle further comprising:
a receiver for receiving said transmission, said receiver further comprising an interface for converting said transmission back to said data stream; and
a portable computer for receiving said data stream, said portable computer further configured to identify the vending machine and sales data for the vending machine, so as to enable said service operator to obtain inventory from said service van and convey same to the vending machine, so as to stock said vending machine without a physical inventory of the vending machine.

2. The vending machine service system of claim 1, wherein said compiled data of said monitoring interface includes data on cash receipts and change requirements for the vending machine, and wherein said portable computer is programmed to convey data on cash receipts and change requirements.

3. The vending machine service system of claim 2, wherein said compiled data of said monitoring interface includes service information on the operational status of the vending machine, and wherein said portable computer display indicates data on service information for the vending machine.

4. The vending machine service system of claim 3, wherein there is provided a second monitoring interface engaging a second vending machine located a distance from said first vending machine, said second monitoring interface formed to compile data on the operation of the second vending machine, providing compiled data comprising machine identification and sales data on the second vending machine, said second monitoring interface further formed to format said compiled data into a second data stream;
a second transmitter for transmitting said data stream to said reception area, providing a second transmission;
wherein said receiver is formed to receive said second transmission, providing said second data stream; and
said portable computer is provided for receiving said second data stream, said portable computer further utilizing said second data stream to identify the second vending machine and providing sales data for the second vending machine from said second data stream, so as to enable said service operator to obtain inventory from said service van and convey same to the second vending machine, so as to stock said second vending machine without a physical inventory of the second vending machine.

5. The vending machine service system of claim 4, wherein there is provided a third monitoring interface for monitoring a third vending machine located a distance from said first and second vending machines, said third monitoring interface formed to compile data on the operation of the third vending machine, providing compiled data comprising machine identification and sales data on the third vending machine, said third monitoring interface further formed to format said compiled data into a third data stream;
a third transmitter for transmitting said data stream to said reception area, providing a third transmission;
wherein said receiver is formed to receive said third transmission, providing said third data stream; and
said portable computer is further provided for receiving said third data stream, said portable computer further utilizing said third data stream to provide third vending machine and sales data for the third vending machine, so as to enable said service operator to obtain inventory from said service van and convey same to the third vending machine, so as to stock said second vending machine without a physical inventory of the third vending machine.

6. A vending machine service system for transmitting one-way vending data from a vending machine to a service operator, comprising:
a monitoring interface for monitoring a plurality of vending machines situated at disparate locations relative one another within a local area, said monitoring interface comprising individual monitor modules for compiling data on the operation of said plurality of machines, providing compiled data comprising machine identification and sales data on each of said vending machines, said monitoring interface further formatting said compiled data into a data stream;
a transmitter for transmitting, via mono-directional transmission only, said data stream to a reception area, providing a transmission;
a service vehicle situated in said reception area, said service vehicle for conveying an inventory of product for each of said vending machines, said service vehicle further comprising:
a receiver for receiving said transmission, said receiver further formed to converting said transmission back to said data stream; and
a portable computer for receiving said data stream, said portable computer further comprising an indicator for conveying to a service operator the identification of each of said vending machine and sales data for each of said vending machines, so as to enable said service operator to obtain inventory from said service van and convey same to each of said vending machines, so as to stock said vending machine without a physical inventory of each of said vending machines.

7. The vending machine service system of claim 6, wherein said compiled data of monitoring interface includes data on cash receipts and change requirements for each of said vending machines, and wherein said indicator of said portable computer conveys data on cash receipts and change requirements.

8. The vending machine service system of claim 7, wherein said compiled data of said monitoring interface includes service information on the operational status of each of said vending machines, and wherein said indicator of said portable computer conveys data on service information for each of said vending machines.

9. The vending machine service system of claim 8, wherein said portable computer further comprises uploading means to upload said data stream to an administrative office and downloading means to download said data stream to said portable computer.

10. The vending machine service system of claim 9, wherein said monitoring interface appends to said data stream location information on the location of each of said vending machines, and wherein said indicator of said portable computer display conveys to the service operator location information for each of said vending machines.

11. The vending machine service system of claim 10, wherein there is further provided a route indicator with said portable computer to utilize said location information to convey to said service operator a preferred route for the service of each of said vending machines.

12. The method of servicing a plurality of vending machines situated at disparate locations relative to one another within a location area, comprising the steps of:
a) compiling vending machine data to update sales and cash flow information, providing operational status and machine ID information on each said vending machine, so as to provide an updated data stream for each machines
b) repeatedly transmitting each said updated data stream, consisting of the sub-step of transmitting via monodirectional transmission said updated data stream via transmitters in each said disparate location;
c) adjusting the transmission characteristics of each said transmitters, at each said disparate location so as to provide multiple overlapping transmissions from said separate transmitters to a single designated reception area;
d) repeating steps a-b so as to provide continuously updated data streams for each machine, such that said data streams are continuously conveyed to said designated reception area in approximate real time, while
e) positioning a service vehicle within said reception area;
f) receiving said multiple overlapping transmissions from each of said separate transmitters at said service vehicle within said reception area, providing received data streams;
g) uploading said received data streams to a portable computer;
h) utilizing said portable computer to compile said data streams, and display inventory data, then utilizing said service personnel to pull inventory from said service vehicle utilizing said inventory data;
i) utilizing said portable computer to indicate the location and route of the vending machines, while conveying said pulled inventory from said service vehicle to said vending machines;
j) stocking each said vending machine as needed utilizing said pulled inventory in the order indicated by said portable computer;
k) discerning vending machine activity relating to coin box or product inventory changes from the period of reception of said received data at the service vehicle, to the point where each vending unit is opened for replenishing inventory and indicating any such changes on said portable computer upon servicing each said vending machine in order to compensate for any activity from the period of reception at the service vehicle to the point when the unit is serviced, providing adjusted received data; then
l) resetting each vending machine at said machine location, so as to include the inventory stocked in each machine in step “j”.

13. The method of claim 12, wherein after “l.”, there is further provided the additional steps of:
m. communicating, via said portable computer, said adjusted received data to a base office.

14. The method of servicing a plurality of vending machines situated at disparate locations relative to one another within a location area, comprising the steps of:
a) polling each said machine, compiling identification, and updated product sales and cash flow data for each machine, providing an updated data stream;
b) repeatedly transmitting said updated data stream utilizing monodirectional
RF transmission only, via a transmitter located in the vicinity of each of said disparate locations, at predetermined intervals, providing overlapping transmissions to a single reception area;
c) repeating steps a-b so as to provide continuously updated data streams for each machine, such that said updated data streams are conveyed to said designated reception area in approximate real time, while
d) providing a service vehicle having product inventory for said vending machines;
e) positioning said service vehicle within said reception area;
f) receiving said transmissions from said transmitter, providing a received data stream;
g) said received data stream providing to service personnel sales and cash flow data for each vending machine conveyed in said received data stream, providing a picking ticket at said service vehicle;
h) pulling inventory from said service vehicle based upon said picking ticket, providing pulled inventory;
i) stocking each said vending machine as needed utilizing said pulled inventory.
j) discerning vending machine activity relating to coin box or product inventory changes from the period of reception of said received data at the service vehicle, to the point where each vending unit is opened for replenishing inventory; and
k) resetting each vending machine at said machine location, so as to include the inventory stocked in each machine in step “l.”.

15. The method of claim 14, wherein after step “k.”, there is further provided the additional steps of:
l. adjusting said received data to accommodate said vending machine activity in step “l”, so as to balance out each vending machine, providing adjusted received data; and
m. providing said adjusted received data to a base office.

16. The method of claim 15, wherein after step “g.” there is provided the additional step of providing location information on each said vending machine, and discerning an optimal route order for the servicing of each said vending machine, and providing sales and cash flow data for each said vending machine in said optimal route order.

17. The method of servicing a vending machine, consisting of the steps of:
a) polling said machine, compiling sales, inventory, and cash flow data, providing a data stream;
b) repeatedly transmitting said data stream, utilizing monodirectional RF transmission only, providing a transmission to a reception area;
c) repeating steps a-b so as to provide a continuously updated data stream for said machine, such that said data stream is conveyed to said designated reception area in approximate real time, while
d) providing a service vehicle having product inventory for said vending machine;
e) positioning said service vehicle within said reception area;
f) receiving said monodirectional RF transmission in said reception area, providing received data;
g) providing sales and cash flow data for the vending machine, providing a picking ticket;
h) pulling inventory from said service vehicle based upon said picking ticket, providing pulled inventory;
i) stocking said vending machine utilizing said pulled inventory;
j) discerning vending machine activity relating to coin box or product inventory changes from the period of reception of said received data at the service vehicle, to the point where each vending unit is opened for replenishing inventory; and
k) resetting each vending machine at said machine location, so as to include the inventory stocked in each machine in step “l.”.

18. The method of claim 17, wherein after “k.”, there is further provided the additional steps of:
l. adjusting said received data to accommodate said vending machine activity in step “l”, so as to balance out each vending machine, providing adjusted received data; and
m. providing said adjusted received data to a base office.

19. The method of servicing a vending machine, comprising the steps of:
a) receiving a data stream from the vending machine via a monitoring assembly;
b) removing data from said data stream unrelated to inventory, cash, operational status, or machine ID utilizing programming in said monitoring assembly, providing an abbreviated data stream;
c) preparing a transmission string including an identification of the machine, inventory, cash data, and/or operational status of said machine from said abbreviated data stream, and forwarding said transmission string to a transmitter module;
d) transmitting, then re-transmitting, utilizing one-way RF transmission only, said transmission string to a targeted reception area, so as to provide a continuous data transmission; while
e) updating said transmission string as new data is received;
f) repeating steps a-e for other vending machines in the vicinity, so as to provide multiple transmissions to said targeted reception area, such that each said transmission conveys a data stream to said targeted reception area which is updated in approximate real time;
g) positioning a service vehicle within said targeted reception area;
h) receiving said transmissions at said service vehicle;
l) inputting said transmissions into a portable computer;
j) conveying said transmissions via said portable computer to a route operator operating the service vehicle providing received data;
k) allowing said route operator to pull inventory and money change from said service vehicle for servicing each of said vending machines so as to provide stock for filling said vending inventories;
l) stocking each said vending machine utilizing said pulled inventory and money change from said service vehicle
m) discerning vending machine activity relating to coin box or product inventory changes from the period of reception of said received data at the service vehicle, to the point where each vending unit is opened for replenishing inventory; and
n) resetting each vending machine at said machine location, so as to include the inventory stocked in each machine in step “i.”.

20. The method of claim 19, wherein there is further provided the additional step “O.” of adjusting said received data to accommodate said vending machine activity in step “m”, so as to balance out each vending machine, providing adjusted received data; and
p. downloading said adjusted received data from the portable computer to a base office.

21. The method of claim 20, wherein there is further provided the additional step “q.” of allowing the service personnel to convey said machine inventory to said next machine;
r) repeating steps “l” through “p” until each of said vending machines is stocked;
s) returning to the service vehicle with the portable computer;
t) downloading said adjusted received data from the portable computer to a base office.

22. The method of servicing a vending machine, comprising the steps of:
a) utilizing a receiver interface to receive data from a vending machine, providing received data;
b) compiling said data to discern activity, providing filtered received data;
c) preparing said filtered received data, providing a transmission string;
d) communicating said transmission string to a reception area consisting of the step of transmitting, utilizing mono-directional RF transmission, said transmission string to targeted reception area wherein said vending machine is located;
e) repeating steps a-d so as to provide a continuous transmission of data for said vending machine to said designated reception area which is updated in approximate real time, while
f) positioning a service vehicle within said reception area;
g) receiving said transmission, providing received data;
h) utilizing said received data from said transmission to pull inventory and money change from said service vehicle for servicing said vending machine, providing pulled inventory;
l) conveying said pulled inventory to said vending machine;
j) stocking said vending machine;
k) discerning vending machine activity relating to coin box or product inventory changes from the period of reception of said received data at the service vehicle, to the point where each vending unit is opened for replenishing inventory;
l) adjusting said received data to accommodate said vending machine activity in step “k”, so as to balance out each vending, providing adjusted received data
m) resetting said vending machine, resetting said filtered received data.
